(19) United States
(12) Patent Application Publication
(10) Pub. No.: US 2009/0071049 A1
(43) Pub. Date: Mar. 19, 2009

(54) Projection-Type Advertisement Device

(76) Inventor: Jinsong Lan, Guangzhou (CN)

Correspondence Address: GLOBAL IP SERVICES, 7285 W. Eagle Court, Winton, CA, 95388, US

(21) Appl. No.: 12/017,718

(22) Filed: Jan. 22, 2008

(30) Foreign Application Priority Data
Sep. 13, 2007 (CN) 200720056960.5

(51) Int. Cl. G09F 11/18

(52) U.S. Cl. 40/471

(57) ABSTRACT

The instant invention discloses a projection-type advertisement device. The purpose of the invention is to provide a simple-structure, convenient-used billboard. The technical points of the invention is that the invention comprises a support and an advertisement board fixed on the support, wherein a projector is provided in front of at least one advertisement faceplate of the advertisement board, and the projecting direction of the projector faces to the advertisement faceplate of the advertisement board; a rolling screen is provided ahead of the advertisement faceplate of the advertisement board; and a roller is provided on the two sides of the advertisement board, the roller having a drive device. The invention is used for advertisement propagandizing

### CROSS REFERENCE TO RELATED PATENT APPLICATION

This application claims the priority of the Chinese patent application No. 200720056960.5 with filing date of Sep. 13, 2007.

### FIELD OF THE INVENTION

The instant invention relates to a billboard, and more particularly to a projection-type advertisement device.

### BACKGROUND OF THE INVENTION

At present, because the contents of advertisement pictures, of outdoor billboards mounted at stations, roadsides and so on, are generally fixed on billboards by pasting or spraying or other methods, the outdoors billboards can't at the same time propagandize different products of one consumer or different products of several consumers so that causes a high using cost of billboards and also goes against efficiently using of golden locations of advertisement. Moreover, advertisement pictures are generally used by renting. When an old advertisement agreement expires, changing advertisement pictures has to be done. Changing advertisement pictures is relatively easy for small billboards mounted at stations and so on. However, changing advertisement pictures is very difficult for large billboards mounted on the roadsides and thus using such billboards is discommodious. In order to change such a situation, someone develops a three-faceplate billboard for which pictures can be changed. There are also some other advertisement boards for which pictures can be changed circularly inside the boards to show several different advertisement pictures in turn. This type of billboards generally mounted at marketplaces, at stations and so on used as small billboards and is not suitable to be mounted on roadsides as large billboards.

### SUMMARY OF THE INVENTION

The purpose of the invention is to provide a simple-structure, convenient-used, projection-type advertisement device to overcome the disadvantages of prior art.

The technical solution of the invention is: a projection-type advertisement device, comprising a support and an advertisement board fixed on the support, wherein a projector is provided in front of at least one advertisement faceplate of the advertisement board, and the projecting direction of the projector faces to the advertisement faceplate; a rolling screen is provided ahead of the advertisement faceplate of the advertisement board; and a roller is provided on the two sides of the advertisement board, the roller having a drive device.

The said projector of the projection-type advertisement device is fixed on the upper side portion of the advertisement board by a rack such that will not block off the line of sight.

The instant invention a projection-type advertisement device uses the above structures, that is, a projection device is mounted in front of a advertisement board. Thus advertisement propagandizing can be done by the projection device. Such a projection-type advertisement billboard has simple structure, and extends contents of advertisement propagandizing. Its advertisement pictures changes more conveniently, and using of it is more effective.

### DESCRIPTION OF THE DRAWINGS

The invention will be described in detail by combining the embodiment shown by the drawings of the invention, without any limit of the protection scope of the invention.

FIG. 1 is a perspective structure view of a projection-type advertisement device according to an embodiment of the invention;

FIG. 2 is the left view of FIG. 1.

In the drawings including: a support 1, advertisement board 2, a projector 3, a rolling screen 4, a roller 5, a drive device 6, and a rack 7.

### DETAILED DESCRIPTION OF THE INVENTION

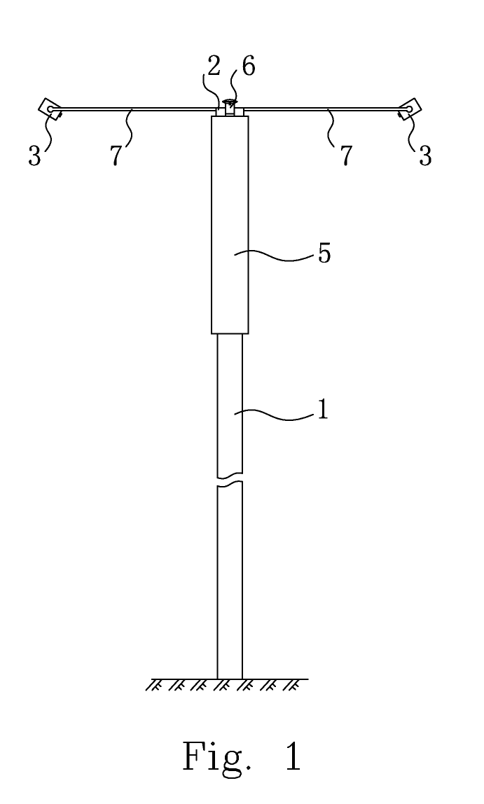

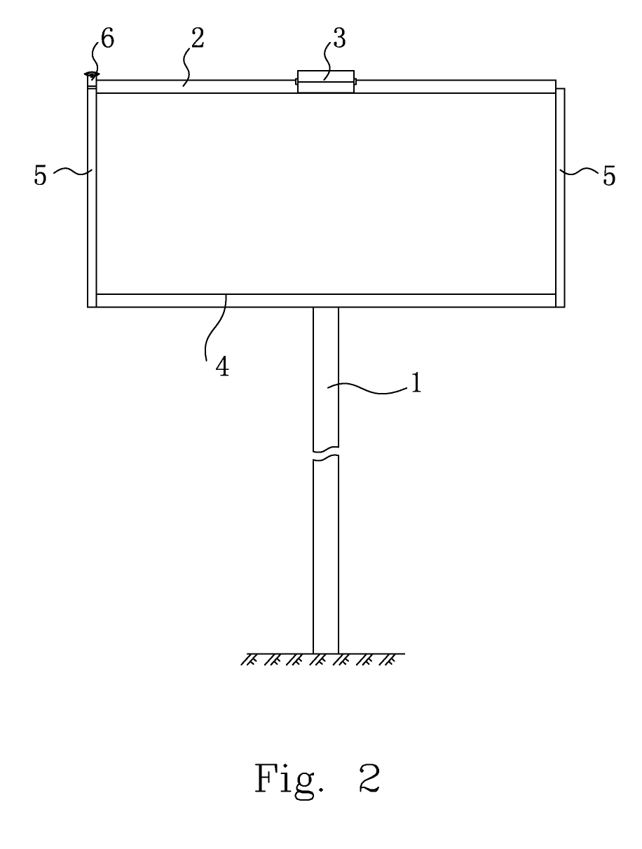

Referring to FIG. 1 and FIG. 2, the instant invention, a projection-type advertisement device, is a large billboard which comprises a support 1 and an advertisement board 2 fixed on the support. A projector 3 is provided in front of each advertisement faceplate at the two sides of the advertisement board 2, and the projecting direction of the projector 3 faces to the advertisement faceplate of the advertisement board 2. The projector 3 is fixed on the upper side portion of the advertisement board 2 by a rack 7. A rolling screen 4 is provided ahead of each advertisement faceplate at the two sides of the advertisement board 2; a roller 5 is provided on the two sides of the advertisement board 2, the roller 5 having a drive device 6. When the rolling screen 4 is not used, the roller 5 can roll the rolling screen 4 into it by the drive device 6, or the rolling screen 4 can be drawn out from the roller 5 by the drive device 6.

Using the invention, advertisement pictures can be fixed on the advertisement board 2 by pasting or spraying or other methods for propagandizing. By using the projector 3 and the rolling screen 4 together can play different advertisement pictures so as to add the using ratio and to improve the using value of the of the advertisement locations.

What is claimed is:

1. A projection-type advertisement device comprising:
a support (1); and
an advertisement board (2) fixed on the support;
wherein a projector (3) is provided in front of at least one advertisement faceplate of the advertisement board (2), and the projecting direction of the projector (3) faces to the advertisement faceplate;
a rolling screen (4) is provided ahead of the advertisement faceplate of the advertisement board (2); and
a roller (5) is provided on the two sides of the advertisement board (2), the roller having a drive device (6).

2. The projection-type advertisement device as claimed in claim 1, wherein the projector (3) is fixed on the upper side portion of the advertisement board (2) by a rack (7).
